(19) United States
(12) Patent Application Publication
(10) Pub. No.: US 2010/0091248 A1
(43) Pub. Date: Apr. 15, 2010

(54) Novel System and Method of Creating a Visual Display

(76) Inventor: Peter Sarkisian, Santa Fe, NM (US)

Correspondence Address: KEITH D. NOWAK, CARTER LEDYARD & MILBURN LLP, 2 WALL STREET, NEW YORK, NY, 10005, US

(21) Appl. No.: 12/248,976

(22) Filed: Oct. 10, 2008

(51) Int. Cl. G03B 21/26

(52) U.S. Cl. 353/30

(57) ABSTRACT

A novel system and method of creating a three-dimensional display includes displaying a composite image on a screen display having at least one contoured space. The composite image comprises at least one separate image being dimensioned and configured to fit specifically within said at least one contoured space. The composite image may include portions that are capable of motion. The visual display, in effect, functions as a three-dimensional movie screen and enters a viewer space.

### PRIORITY AND RELATED APPLICATION

N/A

### FIELD OF THE INVENTION

The present invention relates to displays, specifically to visual displays having dimension for exhibiting an image.

### BACKGROUND OF THE INVENTION

Visual displays maybe used for a variety of purposes such as art, education, marketing, etc. Prior art visual displays are basic, including simple flashing neon lights or even a painted sign backlit with a fluorescent light. For instance, a traditional soda vending machine may display a glossy picture of a cola drink or the name of the drink on a front wall of the machine that is backlit with a bright light from behind. More modern visual aids employ high tech elements that far surpass the visual displays of the past. For instance technological components such as computers and fiber optics may be incorporated in today's visual displays. However, there is need for a novel system and method of creating a visual display wherein the visual display functions as a three-dimensional movie screen and enters a viewer space. Such a novel visual display should appear three-dimensional and provide the viewer with a three-dimensional viewing experience. It is also desired that as part of the three-dimensional viewing experience that the screen used to view images be contoured to images being displayed thereon.

### BRIEF SUMMARY OF THE INVENTION

The present invention provides a novel system and method of creating a visual display. The visual display includes exhibiting a composite image on a screen which has at least one contoured space. The composite image comprises at least one separate image being dimensioned and configured to fit specifically within said at least one contoured space. The composite image may include portions that are capable of motion.

### BRIEF DESCRIPTION OF THE DRAWING

FIG. 1 is a front view of a visual display of the present invention displaying a composite image.

FIG. 2 is a side perspective view of a screen of the visual display of the present invention exhibiting a composite image.

FIG. 2b is a rear perspective view of the screen of the visual display of the present invention.

FIG. 3a is a side perspective view of the visual display of the present invention showing angles of contoured spaces on a screen of the visual display of the present invention.

FIG. 3b is a side perspective view of the visual display of the present invention employing one projector.

FIG. 3c is a side perspective view of the visual display of the present invention employing two projectors.

FIG. 3d is a side perspective view of the visual display of the present invention defining depth planes.

FIG. 4 is a perspective view of one embodiment of an alignment tool employed in the present invention.

FIG. 5a is a front view of a mounting panel.

FIG. 5b is a side perspective view of a mounting panel.

FIG. 6 is a rear perspective view of a mounting panel with a screen attached thereto.

### DETAILED DESCRIPTION OF THE INVENTION

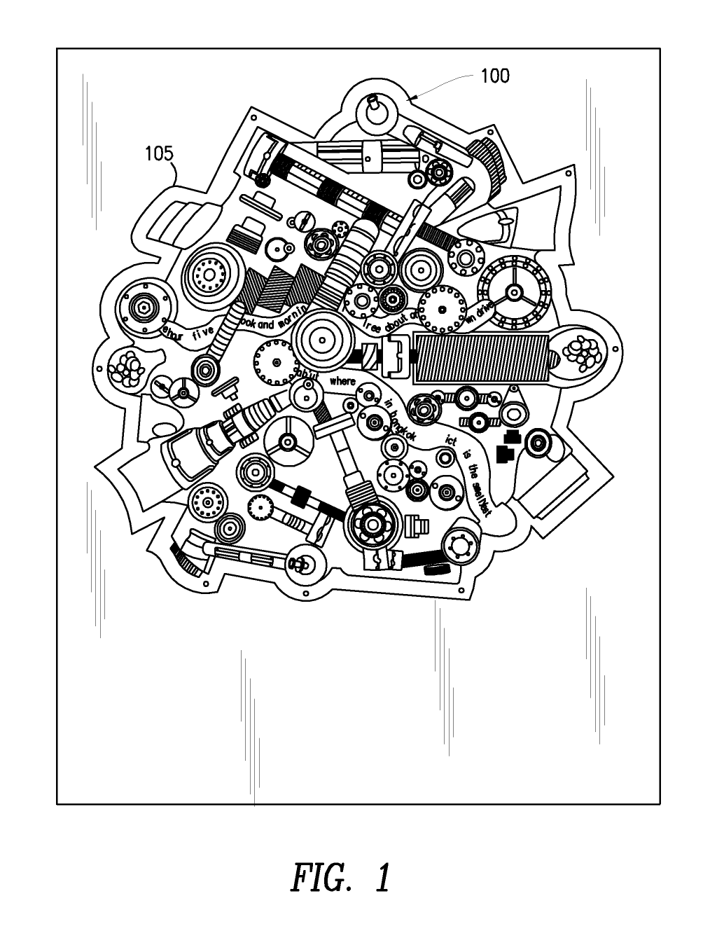

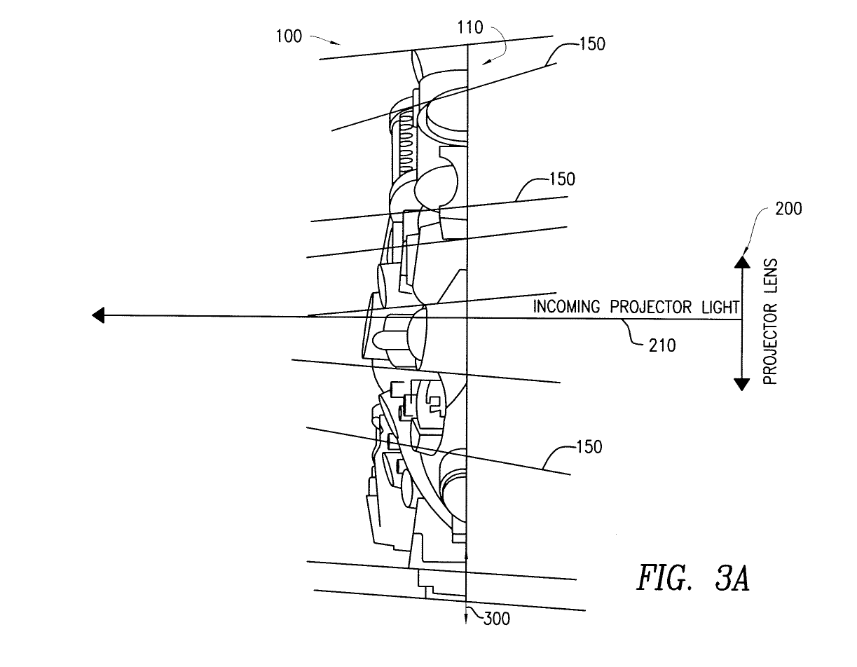

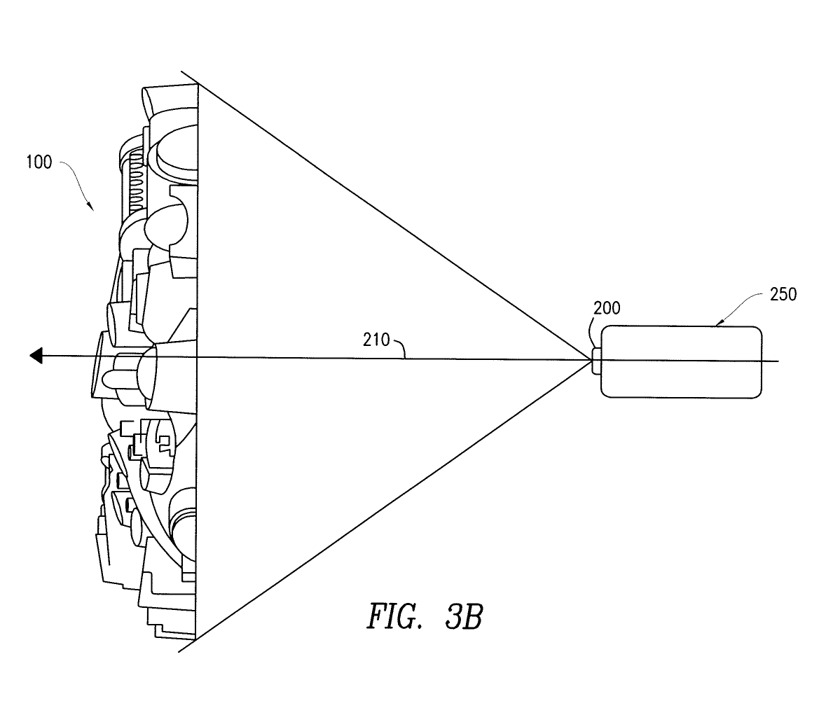

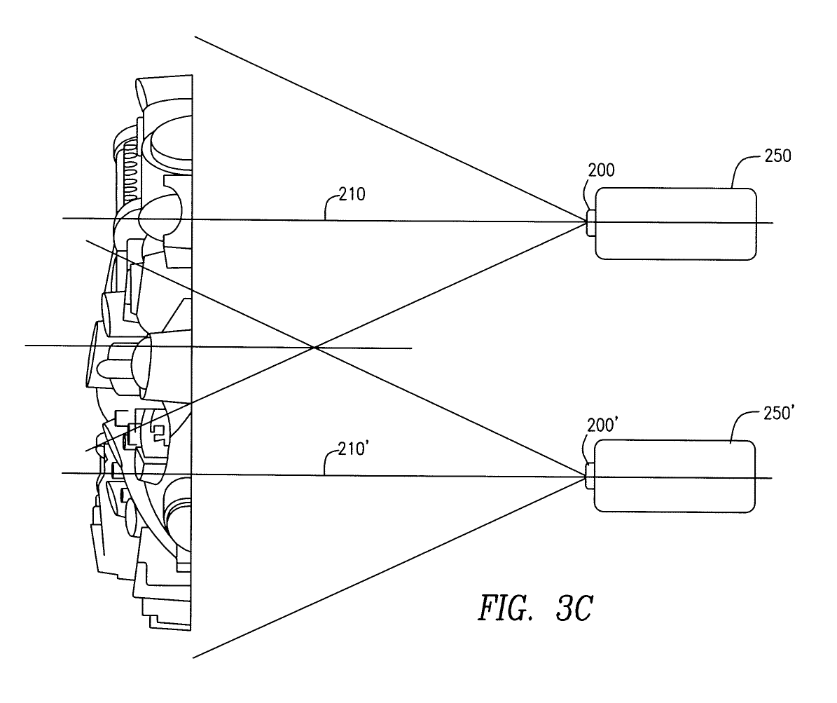

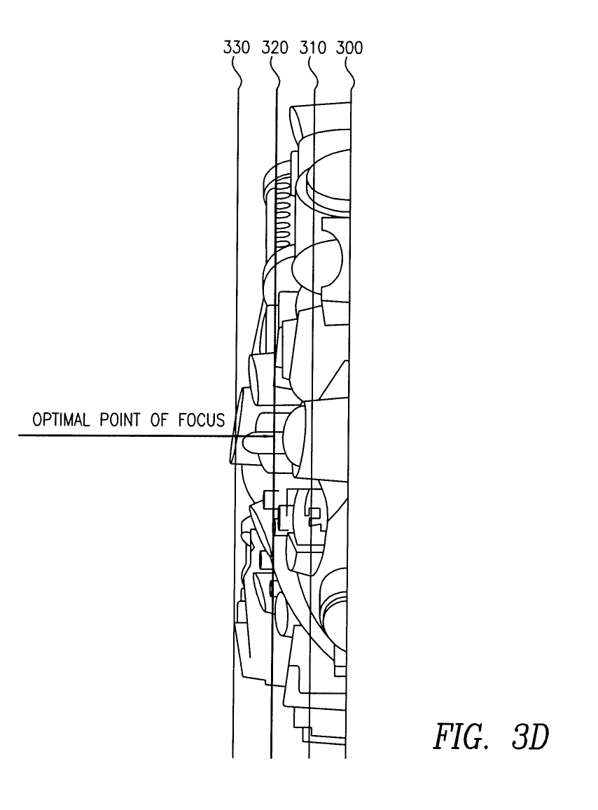

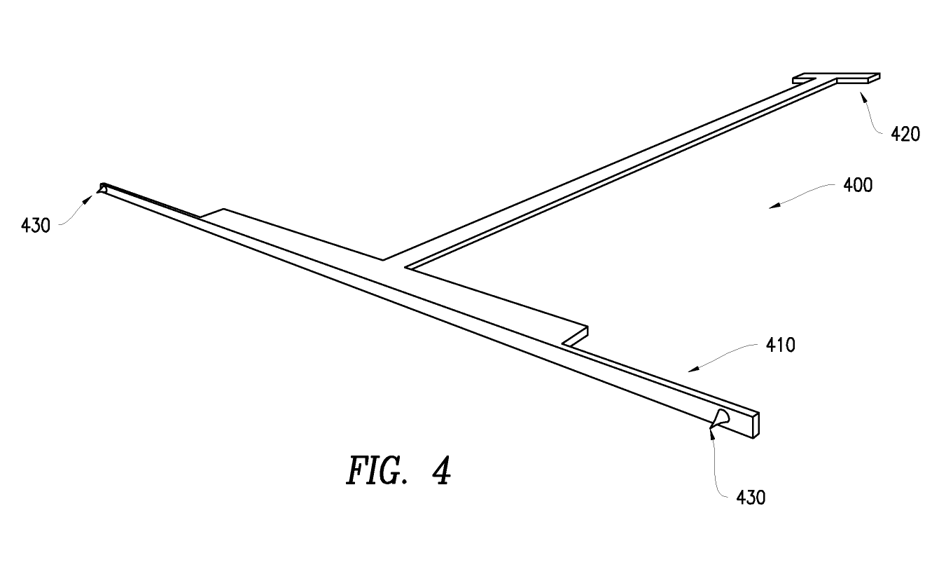

The present invention discloses a novel system and method of creating a visual display, said visual display may be a three-dimensional visual display providing a three-dimensional viewing experience to viewers. The visual display can function as a three-dimensional movie screen that enters a viewer space. The visual display comprises a screen 100 and at least one projector 250 for projecting the composite image on the screen 100, see FIGS. 1, 3a and 3b. Screen 100 shown in the figures depicts one non-limiting example used herein to describe the present invention.

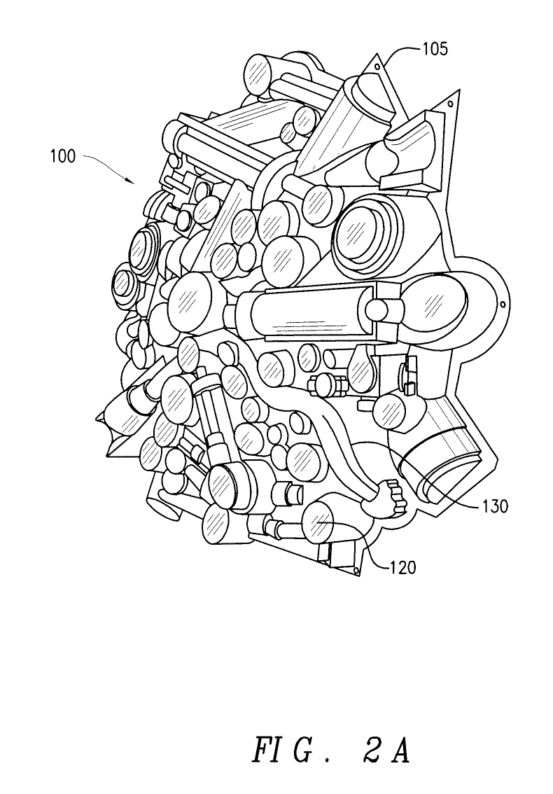

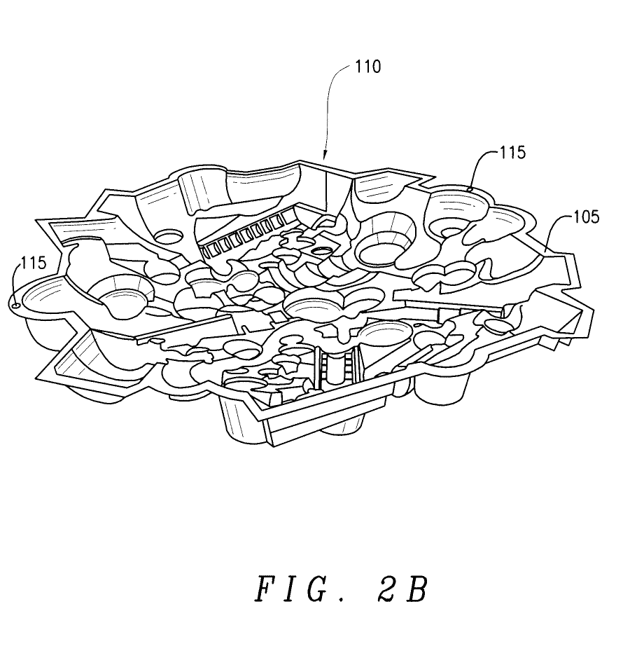

The screen 100 is a volumetric, spatially extruded screen having a collar 105, at least one contoured space and a cavity 110, see FIGS. 2a and 2b. The screen 100 and the contoured spaces are designed to enter the viewers space by rising out of the screen 100. The present invention employs at least one contoured space and in a preferred embodiment, the display has a plurality of contoured spaces 120, 130. The spaces 120, 130 may take any shape including the shape of letters or words, faces, bodies, landscape, nature images, architectural or industrial images etc.

As shown in FIG. 2a, contoured space 120 is a circular shape, while contoured space 130 is a tubular space. The contoured spaces 120, 130 provide a complex and varied three-dimensional screen topography that does not break up the screen 100. The contoured spaces may have a specified size such as diameter, depth, etc. and have different levels or surfaces. See FIGS. 2a and 3a. Each surface of the contoured spaces may be angled differently, as represented by plane 150, so as not to be perpendicular to a projector lens 200 or parallel to incoming projector light 210. See FIG. 3a.

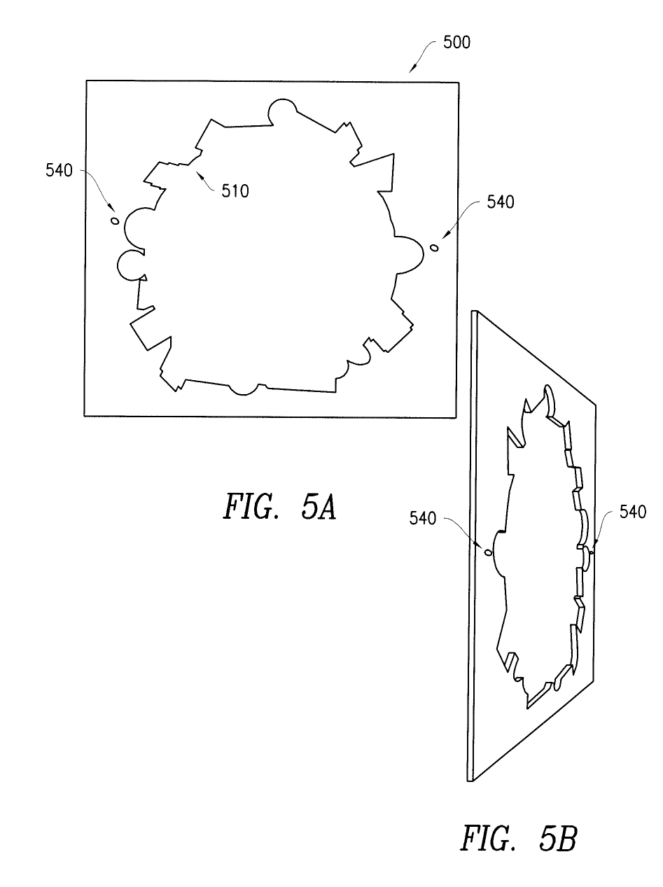

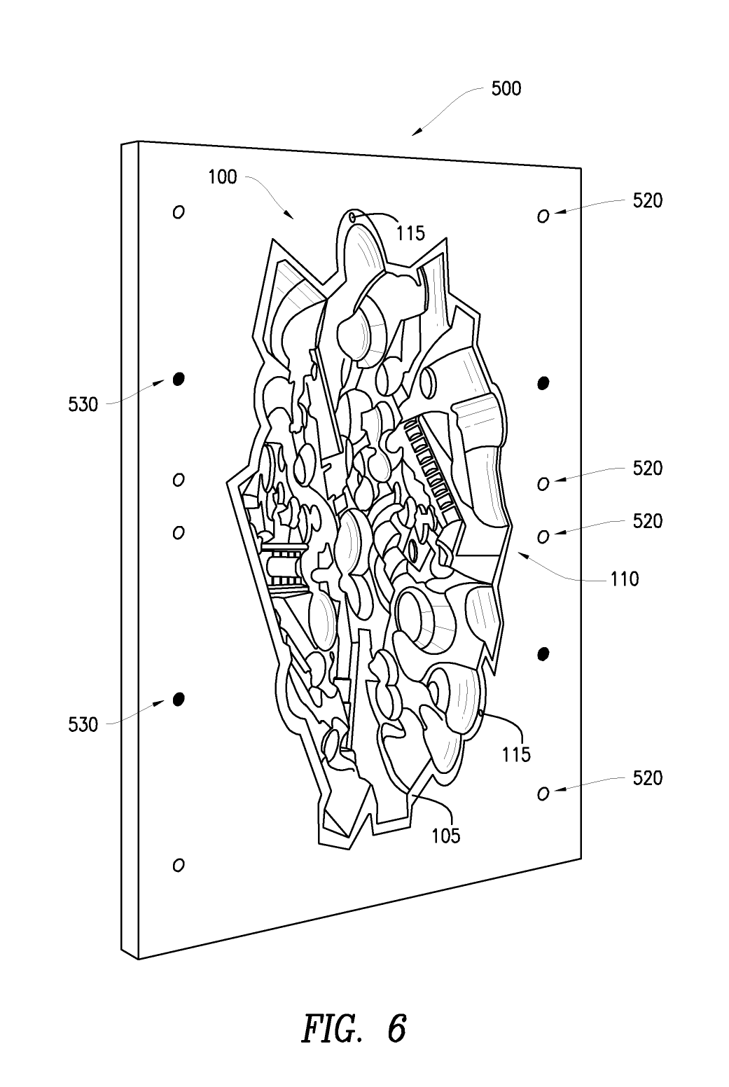

The screen 100 possesses a collar 105, see FIG. 2b. The collar provides a surface to mount the screen 100 directly on a surface or a mounting panel 500 using screen calibration points 115 located on the collar and corresponding points 540 located on a mounting panel, see FIGS. 5a and 5b. It should be noted that an established plane surface 300 or a known variable useful for consistent spatial orientation of the composite image will be employed in the present invention. In one embodiment, where the collar 105 is disposed directly on a surface, the collar 105 serves as the plane surface 300, see for example FIGS. 3a and 3d. In another embodiment, when the collar 105 is attached to a mounting panel 500, the mounting panel serves as the plane surface 300, see generally FIG. 6. Furthermore, calibration points may be disposed on the plane surface 300 to assist in focusing and calibrating the composite image on the screen 100 during production and installation. See FIG. 6. These calibration points may be on the collar 105 or mounting panel 500 or both. Calibration points include screen calibration points 115, image calibration points 520 and alignment tool calibration points 530.

Screen 100 shows the collar 105 following the outline of the screen 100 to form a boarder or perimeter adjacent the contoured spaces. However, in some embodiments, the collar may be fashioned to be offset by a distance from the screen 100 in a stepped manner to form a stepped collar. The stepped collar may be utilized with a screen regardless of whether the screen is comprised entirely of contoured spaces or whether the screen 100 comprises one contoured space with the remaining area of the screen being flat. For instance, looking at FIG. 2a, if screen 100 were fabricated to have a stepped collar, the collar 105 of screen 100 should first be wider than that shown in the figures and then folded twice at right angles to form an “L” shape depending from collar 105. The portion of the stepped collar farthest from the screen 100 would then be attached to a surface or mounting panel. In some instances, the stepped or offset collar provides additional support to the screen 100 thereby increasing its rigidity.

As mentioned above, the screen 100 may be disposed for display by directly attaching the collar 105 or stepped collar to a surface or by attaching the collar to a mounting panel 500. When the collar 105 employs a mounting panel, the collar 105 is not directly attached to the surface, rather it is the mounting panel that is directly attached to the surface.

Mounting Panel

Looking at FIGS. 5-6, a mounting panel 500 is shown used with screen 100. The mounting panel may consist of a flat single-plane sheet of ridged material, such as and not limited to metal, wood or plastic, and must include an opening 510. In general, the shape of the opening 510 matches the shape of the collar 105 or mirrors the outline of the collar 105. The opening 510 is designed so images can enter the cavity 110 and project on the rear surface of the contoured screen 100 without obstruction from the mounting panel.

Screen calibration points 115 positioned on collar 105 will match pre-cut holes or calibration points 540, on the panel 500 and encircle the opening 510. The pattern for the screen calibration points 115 and 540 may be established prior to image compositing, allowing the screen 100 to be removed and reattached later without compromising alignment relative to image calibration points 520 located on the mounting panel 500 and within the composite image.

The single-plane collar 105 of the screen 100 is attached to either the front or rear surfaces of the mounting panel 500. FIG. 1 shows the collar 105 attached to the front of a surface, while FIG. 6 shows the collar 105 attached to a rear surface of a mounting panel with the front of the contoured screen 100 fitting through the opening 510 in the panel 500. In the orientation shown in FIG. 6, a viewer viewing the screen 100 from the front sees the contoured topography of the screen while the collar 105 is concealed from view. As long as the perimeter collar 105 of the contoured screen 100 remains slightly larger than the hole cut in the mounting panel 500, and as long as the contoured spaces 120 and 130 of screen 100 remain slightly smaller than the opening 510 in the mounting panel 500, the contoured screen 100 can be positioned against the front or rear surface of the mounting panel 500 directly in line with the opening 510 without the composite images from the projector 250 being blocked by the panel 500.

The mounting panel 500 with screen 100 may be designed for display alone or after being attached to any surface. For instance, the mounting panel 500 may also be incorporated as part of another structure, such as a cabinet, table, vehicle, wall, building, etc., and may be mounted in any position, whether that position is vertical, horizontal, diagonal, facing up or facing down. The present invention identifies the importance of keeping the screen flat and the projector and the screen fixed relative to each other, regardless of whether the mounting panel is employed.

The mounting panel 500 may be shaped to match any shaped screen 100. The use of a mounting panel 500 enables the screen 100 to be formed in a variety of shapes and sizes. The panel 500 provides a place to securely mount the screen 100 thereby hindering spatial augmentation such as warping and the like. The mounting panel 500 also enables images to be aligned with the screen 100 using a relatively simple pattern of image and alignment tool calibration points located on the backside of the mounting panel itself. See FIG. 6.

Positioning Image and Alignment Tool Calibration Points Against the Mounting Panel

Calibration points employed with the mounting panel 500 include image alignment calibration points 520 and alignment tool calibration points 530. Image calibration points 520 may be positioned anywhere against the rear surface of the mounting panel 500 as long as the rectangular frame area of the composite image being projected overlaps those areas of the mounting panel 500. This is to ensure that image calibration points located in the composite image correspond with image calibration points 520 on the mounting panel. By positioning calibration points 520 on the mounting panel in this way, the calibration points may be positioned farther out near the corners of a projected frame line rather than being limited to the screen's single-plane collar 105. See FIG. 6. By using the mounting panel 500 with the screen 100, the mounting panel serves as an extension of plane 300 and provides a constant against which the image is created or re-aligned for final playback. Thus, a mounting panel is beneficial when a collar 105 is narrow, leaving little surface area against which to position image calibration points. Placement of image calibration points on the mounting panel is also helpful when portions of the screen remain flat and are used to display composite images or even painted images, if employed. The mounting panel 500 may also retain alignment tool calibration points 530 so that one or more projectors 250 can be positioned relative to the contoured screen 100 using an alignment tool 400 and alignment tool pins 430, discussed infra.

The contoured screen 100 may be either permanently attached to the mounting panel 500 prior to image compositing or temporarily attached to the panel 500. When temporarily attaching the screen 100 to the panel 500 the screen 100 must be able to be removed and later re-attached in the position established prior to image compositing. Here, accurate re-calibration of the screen 100 and mounting panel 500 is necessary in order to maintain proper screen position relative to both image and alignment tool calibration points 520, 530, respectively, located on the back of the panel 500, as well as any composite images originally aligned using the calibration points 520, 530.

Composite Image

FIG. 1 shows a screen 100 displaying a composite image. In the present invention, the composite image comprises at least one separate image. FIG. 1 shows the composite image displaying a plurality of separate images on the screen 100. At least one separate image may be defined within a contoured space 120, 130 of the screen 100, see FIGS. 1 and 2a. Depending on the method used to form the screen 100, at least one separate image may be fit within a contoured space, or vice versa. The composite image may be video or computer generated images and may even be three-dimensional. The images may be displayed using any method including any type of projector. In one embodiment, a 1080p high definition widescreen video projector is used in the present invention. The projector lens should allow for vertical adjustment using mechanical lens shift. The use of high resolution projectors will reduce visible pixel distortion on contoured surfaces that are extremely angled. In some embodiments, projectors with little or no visible pixilation, such as Liquid Crystal on Silicon (LCOS) or Digital Light Processing (DLP) imaging types have been shown to produce the best results.

The composite image can be static or moving and may include calibration points. Examples of images displayed on the screen 100 may include text, shapes or pictures. For instance, one image may be of a rotating gear while another image is of a rolling text or ticker that travels in any direction across a screen or a contoured space. In one example, a rotating gear may be disposed in curved contoured spaces similar to contoured space referred to as 120 while an image of a rolling text or a ticker text may be disposed in a contoured space similar to contoured space referred to as 130. See FIGS. 2 and 3a. Accordingly, the visual display becomes a three-dimensional movie screen.

The image calibration points 520 located on plane 300, whether they are located on the collar 105 or mounting panel 500, are provided along with corresponding calibration points within the composite image to ensure proper alignment of the image when projected against the screen 100. See FIG. 6. By matching calibration points on the collar 105 or mounting panel 500 with corresponding points in the composite image, the composite image may be accurately displayed on the screen 100 and adjusted when required with respect to projector distance, image size, tilt and horizontal/vertical positioning. Thus, the collar 105, mounting panel 500 and points 520 are constants that permit easy calibration with respect to shaping, configuring and positioning the composite image. Without plane 300, the composite image may exist in undeterminable space with arbitrary spatial orientation.

Screen Fabrication

The screen 100 of the present invention may be fabricated using two approaches and may have any total dimension. In one approach, at least one separate image of the composite image is specifically dimensioned and configured to fit or match at least one contoured space of the screen, this method is called screen before image. In the screen before image method, the screen 100 is fabricated first and then the composite image such as computer generated imagery is dimensioned and configured to fit within at least one contoured space on the screen.

In another approach, at least one contoured space is specifically dimensioned and configured to fit or match at least one separate image of the composite image, this method is called image before screen. In the image before screen method, the image is acquired first then the screen is fabricated around the image. Thus, here at least one contoured space is defined in the screen to match a shape of at least one separate image of the composite image thereby in effect wrapping the screen around the image.

Regardless of the method used to make the screen 100, the material used to form the screen may be a thermoplastic resin such as a plastic sheet. Suitable plastics include a clear PPG or other clear material suitable for vacuum forming. Some suitable plastics may include polypropylene, polyethylene including HDPE, PMMA, PVC, polystyrene, acrylonitrile-butadiene-styrene copolymers, among others. In some embodiments, tinted material such as plastics may be used to increase visible contrast. Such material may be useful when viewing the screen 100 in high ambient light environments. Use of a clear tinted material for the screen 100 increases contrast ratio when used for viewing.

The thickness of the plastic material used for the screen may be determined based on a final size of the screen 100 and the overall depth of the screen 100. The plastic sheet used to form the screen 100 should be thick enough so when finally formed as the screen 100, it is hard to the touch and resistant to punctures and other pressures such as sandblasting. The thickness of the plastic must be suitable to be able to conform to a mold and transmit or display images. The plastic material used to create the screen 100 may be weather resistant to be protected from seasonal elements.

The screen 100 is shaped to have contoured spaces by forming, such as by vacuum forming, thermoforming or pressure forming, etc. a plastic sheet over a hard positive mold. The mold may be clay, plaster, wood or other firm material and the mold may be shaped by hand or machined by CNC (computer numerical control) machines or other computer modeling. The plastic sheet is placed over the mold and melted, vacuumed or pressed onto the mold allowing the plastic sheet to conform to the shape of the mold.

Once the plastic sheet is hardened, the screen 100 is created. The rear surface of the screen 100 is then sandblasted to provide a uniform frost. A frosted rear surface enables image transmission so images may show through the front when projected from behind. In a preferred embodiment, a fine white pen sand may be used to create the frosted screen. The sand may be like a powder almost finer than sugar. However, varying levels of frosted granularity can be produced to create different projected results. As an alternative, a chemical agent may be applied to the rear surface to etch the plastic surface or the screen 100 may be sprayed with a scratch resistant opaque surface agent. The front surface of the screen 100 should be smooth, clear and scratch free.

Unlike the image before screen method, the screen before image method requires shape manipulation of separate images. Here, shape manipulation orients the separate image or composite image being composited to fit into contoured spaces so that it appears suited for a contoured space. Shape manipulation is required whether the separate image being projected against its contoured space is text, a shape, such as faces, bodies, landscape, nature images, architectural or industrial images etc. It should be noted that shape manipulated images will appear skewed and distorted when projected onto a flat surface. Accordingly, shape manipulation arranges an image to fit as desired within a contoured space and appear appropriate for the contoured space when the image is viewed from the front of the screen 100.

Positioning

Positioning is an important aspect of the present invention. To realize the visual display of the present invention, it is important to properly position the screen 100 and the projector 250 in relation to each other. The projector may be disposed behind the screen 100. In a preferred embodiment, the screen 100 is perfectly aligned without skew or warp with respect to the projector so that the projector is perpendicular to and centered with the collar 105 or the plane 300 of the screen 100. See FIGS. 3b, 3c and 3d. The screen 100 may be disposed on any surface such as and not limited to a mounting panel, a wall or vertical surface, and edifice cabinet, table, vehicle, etc. An alignment tool, cabinet or other form of armature can be used to register the projector 250 with the plane 300. It should be noted that any number of projectors may be employed with the present invention for projecting the composite image on the screen 100. For instance, looking at FIG. 3c, two projectors 250, 250′ are used. Here, surface area of the screen 100 has been divided between the projectors 250, 250′ thus they can be moved closer to the screen 100 resulting in more clearly resolved images and saved space.

The present invention achieves accurate playback when the screen 100 and the projector 250 are disposed as close as possible to the initial position established when the images where first composited, aligned and adjusted for shape or otherwise established. Proper positioning of the screen and the projector may be achieved using an alignment tool. The tool may be adjustable and may be used to measure a first distance between the projector lens 200 and screen 100 during initial compositing of the image and then to re-establish the distance for final playback or final installation.

FIG. 5 shows one example of an alignment tool 400 having at least one pin 430 on each end of a first end 410 of the alignment tool 400 to correspond with alignment tool calibration points 530 on plane 300, such as the collar 105 and/or mounting panel 500, discussed infra. A second end 420 of the tool 400 is used as a guide for positioning the projector lens 200 at a distance from the screen 100, and to ensure that the projector 250 is perpendicular to and centered relative to the screen 100. Once the screen 100 is aligned with the projector lens 200, image size, tilt and horizontal/vertical position can be fine-tuned. In an alternative embodiment, the alignment tool may be take the form of a tripod wherein three arms project from the second end 420 and each arm has one pin at each end for insertion in calibration points.

As an alternative to the alignment tool, the screen 100 and projector 250 could be mounted relative to each other via a structural cabinet, enclosure or armature (not shown.) Such an arrangement would allow both the screen 100 and projector 250 to be removed and reattached without compromising alignment. For instance, a cabinet could be designed for retaining the screen 100, with or without a mounting panel 500, at one end of the cabinet and one or more projectors 250 disposed at a pre-determined distance from the screen at the opposite end of the cabinet. Use of a cabinet, enclosure or armature facilitates alignment without the need for an alignment tool.

Removing Obstructions to the Projected Image

In both the screen before image and image before screen methods, all surfaces of the contoured spaces 120, 130 are tapered as represented by plane 150. See FIG. 3a. Said planes 150 are not parallel to incoming projector light 210 or perpendicular to lens 200. It is important to taper the surfaces of the contoured spaces 120, 130 so that all surfaces of the screen 100 remain visible from the point of view of the lens 200 and thus remove any possible obstructions to the projected image. Tapering also facilitates removal of the screen 100 from a mold or cast following vacuum forming and permits projector light to strike deep recesses in the contoured screen unobstructed. If surface areas of the contoured spaces are perpendicular to the lens, or parallel to incoming projector light 210 or otherwise have insufficient taper, the image will be obstructed and shadows will be visible in those areas when viewing the screen 100 from the front.

Visual Isolation

Obstructions to the projected image are also removed by visually isolating separate images of the composite image from each other. Visual isolation is accomplished by masking or painting the rear of the screen. In visual isolation by masking, areas of the screen 100 are masked so that images do not actively strike undesired areas of the screen thereby also serving, if desired, to separate composite images. Masking may include taping or painting areas of the screen in which an image is not desired to be displayed. For instance in masking by painting, the collar 105 may be painted black or blocked out so that no image is shown thereon. It should be noted, that the screen may also be painted not to just “black out” the screen, but also to show text, colors or other imagery, thereby enhancing the projected images.

Masking may also be accomplished digitally by masking corresponding video images so that the video only functions within specific contoured portions of the screen. Digital masking effectively crops unwanted light being generated within a given projected frame area from spilling into overlapping image areas being produced by a second video projector 250′. Visual isolation blocks light from a projector lens 200 in areas where no imagery is desired. Looking at FIG. 3a, visual isolation permits multiple projectors 250, 250′ to be used together without the inherent rectangular frame shapes of the projectors overlapping each other and spilling into unwanted areas. Masking thereby prevents overlapping images from being seen from the front of the screen 100. As a means of further removing obstructions to the composite image, contoured spaces 120, 130 in the screen 100 could be positioned to match the digital mask lines within the images being projected and the points at which several overlapping video images coincide.

Depth of Contoured Spaces

Looking now to FIG. 3d, depth of the screen 100 and contoured spaces 120, 130 should be limited to a distance deemed appropriate for the projector 250 being used, as focal length of projector lens 200 vary with make and model. Depth of field can be optimized by limiting the depth of any given screen 100 while also focusing the image projected therein. The optimal point of focus is determined to be a point 320 between the farthest two thirds 300 and 310 of the total depth 330 of the screen 100 relative to the projector lens 200. The point 320 between the farthest two thirds from plane 300 is considered to be the point at which the greatest depth of field can be achieved, and is therefore the point at which the image is to be focused.

It should be mentioned that the projected image can be focused against dominant contoured areas in the screen as well. For example, if the image of a face is contoured in the screen, it may be preferable to focus the image so that the eyes of the face appear sharp, regardless of whether they occur at point 320 as described above. If there is no clearly dominant feature that warrants focusing, then the image should be focused at point 320.

The present invention may be described using the following non-limiting examples.

Image Before Screen Example

A video is made of a car, shown in profile, with steps taken to unsure the car remains an unmoving fixture in the video frame. A hard positive mold is created in the shape of the car using the video image as a guide. The positive mold is created by displaying the video on a stable platform via a video projector. The projector is positioned perpendicular to and at a predetermined distance and scale from the stable platform. The alignment tool 400 may be used to determine or measure the distance between the platform and the lens 200. The image is then molded by hand on the surface of the platform using clay or another material.

The hard positive mold may be any unique shape within the video so that the extruded final screen 100 may possess any number of contoured spaces. For instance, one contoured space may be in the form of the car and another in the form of the road moving beneath the car. Video imagery of the car and its driver could be projected into the car-shaped contoured space while the image of the moving road could be projected into a road-shaped contoured space. Additional images of the car's spinning tires could then be added to enhance the car image. The area around the car and road could then be masked and painted from behind to create visual separation from the contoured area, or the video image itself could be digitally masked during compositing to create said separation. It should be noted that under this method the contoured spaces can be positioned to match mask lines of the video, the composite image.

If desired, a third extruded area in the shape of clouds could be introduced in the sky overhead without the need for a separate screen. All three contoured areas—the car, the road and the clouds—will have been molded from the same single plane surface. All three areas are three-dimensional and rise out of the screen entering the viewer's space. Once the mold is made, a screen 100 with a collar 105 may be formed by vacuum forming a plastic sheet over the hard positive mold. The screen 100 with at least one contoured space is then finished by sandblasting. It should be noted that the single plane surface out of which the three contoured spaces are formed may serve as the collar 105. In an alternative embodiment, the collar may be disposed a distance from the single plane surface in a stepped or offset manner providing added support to the screen 100 and thereby increasing the screens rigidity. In this instance, the plane 300 may be defined by a non-contoured and flat portion of the screen itself and not be the flat portion of an “L” shaped, offset, collar.

To create the visual display the screen 100 is positioned perpendicular to one or more video projectors 250, 250′. Proper positioning may be accomplished using the alignment tool 400. If a single projector configuration is desired, the video source images could be composited together during production so that all three image areas—the car, road and clouds—are combined into one source, enabling playback without the need for additional media players or projectors. By matching image calibration points 520 on the plane 300 with calibration points in the accompanying video image as established during installation an preparation, final playback will be closely aligned to the visual display as when initially prepared.

Screen Before Image Example

FIG. 1 shows a visual display following the screen before image method. Here, each contoured space 120, 130 is designed to receive video or computer generated images specifically designed for the space. See FIG. 1 in conjunction with FIG. 2. The screen 100 is disposed on a surface and projector(s) may be disposed to be perpendicular to the collar 105 using the alignment tool calibration points 530 and alignment tool 400. Separate images are mapped into specific contoured spaces such as those similar to spaces 120, 130 while the position of the projector 250 and screen 100 are fixed. Each separate image would be adjusted to fit in a contoured space by shape manipulation. This may be done one-by-one by hand using digital compositing software. Under this method, mask lines of the composite image would be positioned to match areas of the contoured spaces. In the completed visual display of FIG. 1, the contoured screen 100 has the shape of clustered gears and pistons creating a giant clock-like mechanism. Here the images have been digitally masked and compositied to fit into corresponding contoured spaces in the screen. Generally, each contoured space has an image that is moving to create a three-dimensional movie screen that enters the viewers space.

Screen Before Image Combined with Image Before Screen Example

In this example, the two examples above may be combined so that parts of the screen may be made using the screen before image approach and other parts using the image before screen approach. For example, a screen might be made to combine the contours of a car (image before screen) with the contours of text (Screen Before Image).

The scenarios above allow for the creation of multiple contoured areas within a single sheet of raw material, while also creating a single plane reference 300 used for mounting the screen and calibrating a complex arrangement of video images with relative ease. The arrangement simplifies the image calibration process by combining multiple images into one source, which can then be registered with a single contoured screen relative to an established plane.

While the invention has been described by way of example and in terms of specific embodiments it is not so limited and is intended to cover various modifications as would be apparent to those skilled in this art area. Therefore, the scope of the appended claims should be accorded the broadest interpretation so as to encompass all such modifications.

I claim:

1. A method for creating a display comprising:
providing a screen display, said screen display having at least one contoured space; and
displaying a composite image on said screen display, said composite image comprising at least one separate image being dimensioned and configured to fit specifically within said at least one contoured space,
wherein said screen display exhibits a three-dimensional composite image.

2. The method of claim 1, wherein said composite image is displayed on said screen display by a projector, said screen display being perpendicular to said projector.

3. The method of claim 1, wherein said screen display has a plane surface.

4. The method of claim 3, wherein said plane surface provides at least one calibration point against which said composite image is calibrated.

5. The method of claim 3, wherein said screen display has a depth, focusing said composite image at a farthest two-thirds position from said plane surface of said screen display.

6. The method of claim 1, wherein said separate image is dimensioned and configured to fit specifically within said at least one contoured space by calibration.

7. The method of claim 1, wherein said screen display is plastic, said plastic being extruded to form said at least one contoured space.

8. The method of claim 1, wherein said separate image is capable of motion.

9. A method for creating a display comprising:
providing a screen display, said screen display having a plurality of contoured spaces; and
displaying a composite image on said screen display, said composite image comprising a plurality of separate images, wherein at least one of said plurality of separate images is dimensioned and configured to fit specifically within one of said plurality of contoured spaces,
wherein said composite image is three-dimensional,
wherein said screen display exhibits a three-dimensional composite image.

10. The method of claim 9, wherein said separate images are capable of motion.

11. The method of claim 9, wherein said composite image is displayed on said screen display by a projector, said screen display being positioned perpendicular and level to said projector.

12. The method of claim 9, wherein said screen display has a plane surface.

13. The method of claim 12, wherein said plane surface provides calibration points against which said composite image is calibrated using calibration points disposed in said composite image.

14. The method of claim 12, wherein said plane surface serves as a reference point against which said composite image is created.

15. The method of claim 9, wherein each of said separate images are dimensioned and configured to fit specifically within one of said plurality of contoured spaces by calibration.

16. The method of claim 9, wherein areas between contoured spaces are masked.

17. The method of claim 16, wherein digital masking is employed.

18. The method of claim 9, wherein said composite image has mask lines, said contoured spaces being positioned to match said mask lines of said composite image.

19. The method of claim 9, wherein said composite image has mask lines, said mask lines of said composite image being positioned to match said contoured spaces.

20. The method of claim 9, wherein said screen display has a depth, focusing said composite image at a farthest two-thirds position from a plane surface of said screen display.
